(19) United States
(12) Patent Application Publication
(10) Pub. No.: US 2020/0123326 A1
(43) Pub. Date: Apr. 23, 2020

(54) PHOTOCURABLE POLYSILOXANE COMPOSITION FOR 3D PRINTING, AND DENTAL MOLD COMPRISING SAME

(71) Applicant: VISION TECHNOLOGY KOREA CORP., Yuseong-gu, Daejeon (KR)

(72) Inventors: Ji Jong Park, Yuseong-gu, Daejeon (KR); Eung Chan Lee, Gunpo-si, Gyeonggi-do (KR)

(21) Appl. No.: 16/627,705

(22) PCT Filed: May 23, 2018
(86) PCT No.: PCT/KR2018/005826

§ 371 Date: Dec. 30, 2019

(30) Foreign Application Priority Data
Jun. 28, 2017 (KR) 10-2017-0081943

(51) Int. Cl. C08G 77/12; C08K 5/5397; A61C 13/34; A61C 13/00; C08G 77/20; C08G 77/28; C08K 5/06; A61C 7/08; C08G 77/14; C08K 5/3492; B01J 23/46; B33Y 70/00; B01J 23/44; B33Y 80/00; B01J 23/42

(52) U.S. Cl. CPC C08G 77/12; B01J 23/42; A61C 13/34; A61C 13/0019; C08G 77/20; C08G 77/28; C08K 5/06; A61C 7/08; C08G 77/14; C08K 5/34924; B01J 23/468; B33Y 70/00; C08G 2280/00; B01J 23/44; B33Y 80/00; B01J 23/464; C08K 5/5397

(57) ABSTRACT

The present disclosure relates to a photocurable polysiloxane composition for 3D printing and a dental model including the same. In regard to the photocurable composition for 3D printing, including a novel polysiloxane compound according to one aspect, the cured product thereof exhibits excellent properties in terms of hardness, strength, elongation, coloring resistance against heat, coloring resistance against light, flexural properties, and biocompatibility, and thus the cured product is appropriate for use as a dental material. In addition, since the photocurable composition is liquid and thus the molecular weight and viscosity thereof is easily controllable, the photocurable composition is suitable for a 3D printing process.

### TECHNICAL FIELD

The present disclosure relates to a photocurable polysiloxane composition for 3D printing and a dental model including the same.

### BACKGROUND ART

Regarding a composite resin composition of a silicone resin/organic resin, in general, multifunctional silicone resins are inadequate for non-solvent type 3D printing due to the inevitable use of a solvent since they are typically solid.

In addition, organic polyethylene terephthalate(PET)-based resin, which is currently used mainly for orthodontics, contains a large amount of aromatic rings in the resin skeleton. Thus, the PET-based resin is easily deteriorated by, for example, ultraviolet rays, and the cured product is easily deformed and discolored. In addition, since such organic resins have low performance characteristics in terms of high modulus, strength, and bending, the cured product easily cracks under a rapid-temperature-change environment, such as in cutting or polishing working. In addition, the use of such general-purpose curable organic resins is limited in the medical field requiring biocompatibility because it is not easy to remove the metal catalyst used in the manufacture of the resins.

Therefore, there is a need for a novel liquid silicone resin material for 3D printing, of which cured product has excellent characteristics in terms of strength, elongation, warpage, and biocompatibility.

### DESCRIPTION OF EMBODIMENTS

### Technical Problem

One aspect is to provide a photocurable composition for 3D printing including a novel polysiloxane compound.

Another aspect is to provide a method of preparing the polysiloxane compound.

Another aspect is to provide a dental model including the photocurable composition for 3D printing.

### Solution to Problem

According to an aspect, provided is a photocurable composition for 3D printing including a polysiloxane compound represented by Formula 1.

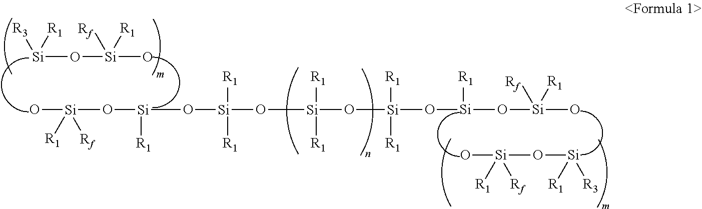

wherein, in Formula 1, R₁ is each independently selected from a C₁-C₃₀ alkyl group or a C₆-C₃₀ aryl group,

R₃ is each independently selected from H, OH, a C₂-C₃₀ alkenyl group, or a C₁-C₃₀ alkoxy group,

R_{f} is a photocurable group,

n is an integer and satisfies the condition of 0≤n≤100, and

m is an integer and satisfies the condition of 0≤m≤20.

According to another aspect, provided is a method of preparing a polysiloxane compound represented by Formula 1 which includes hydrosilylating a compound of Formula 1a and a compound of Formula 1b in the presence of a hydrosilylation catalyst.

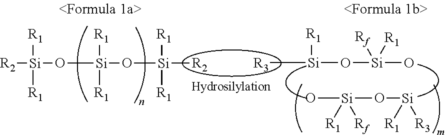

wherein, in Formula 1a and Formula 1b, R₁ is each independently selected from a C₁-C₃₀ alkyl group or a C₆-C₃₀ aryl group,

R₂ and R₃ are each independently selected from H, OH, a C₂-C₃₀ alkenyl group, or a C₁-C₃₀ alkoxy group,

R_{f} is a photocurable group,

n is an integer and satisfies the condition of 0≤n≤100, and

m is an integer and satisfies the condition of 0≤m≤20.

According to another aspect, provided is a dental model including a photocurable composition for 3D printing.

### Advantageous Effects of Disclosure

A photocurable composition for 3D printing including a novel polysiloxane compound according to one aspect is suitable for use as a dental material because the cured product thereof exhibits excellent characteristics in terms of hardness, strength, elongation, coloring resistance against heat, coloring resistance against light, warpage, and biocompatibility. In addition, the photocurable composition is advantageously usable for 3D printing since the photocurable composition is liquid and thus the molecular weight and viscosity thereof can be easily controlled.

### BRIEF DESCRIPTION OF DRAWINGS

FIG. 1 shows an image of a dental model for orthodontics according to an example.

FIG. 2 shows (a) an image of a dental mandibular model for impression, (b) an image of a dental model for orthodontics, and (c) an image of a dental mandibular model with a dental model for orthodontics mounted thereon.

FIG. 3 shows infrared (IR) spectra of the polysiloxane compound represented by Formula 1 according to an example. Here, the photocurable groups of the polysiloxane compound are (a) acryl groups (also referred to as an ‘acryloyl group.’)(Example 1.1.2) and (b) a methacryl group (also referred to as a ‘methacryloyl group’) (Example 1.1.3), respectively.

FIG. 4 shows IR spectra of the polysiloxane compound represented by Formula 1 according to an example before photocuring, before photocuring prebaking at 80° C., and after photocuring, wherein photocurable groups of the polysiloxane compound are (a) an acryl group (Example 1.1.2) and (b) a methacryl group (Example 1.1.3), respectively.

FIG. 5 shows ultraviolet (UV)-visible (Vis) transmission spectra of a photocurable composition according to an example.

FIG. 6 shows (a) an image showing ASTM D638 standard specification and (b) an image of dog-bone specimen of a tensile strength test specimen according to an example.

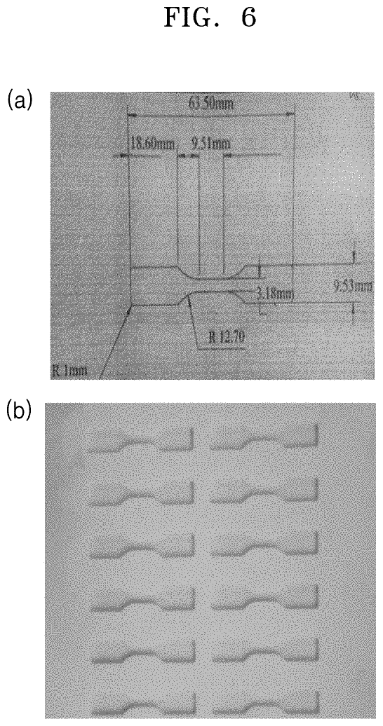

FIG. 7 shows tensile strength and elongation measurement results for tensile strength test specimens according to examples, including (a) the specimen of Example 3.2 and (b) the specimen of Example 3.3.

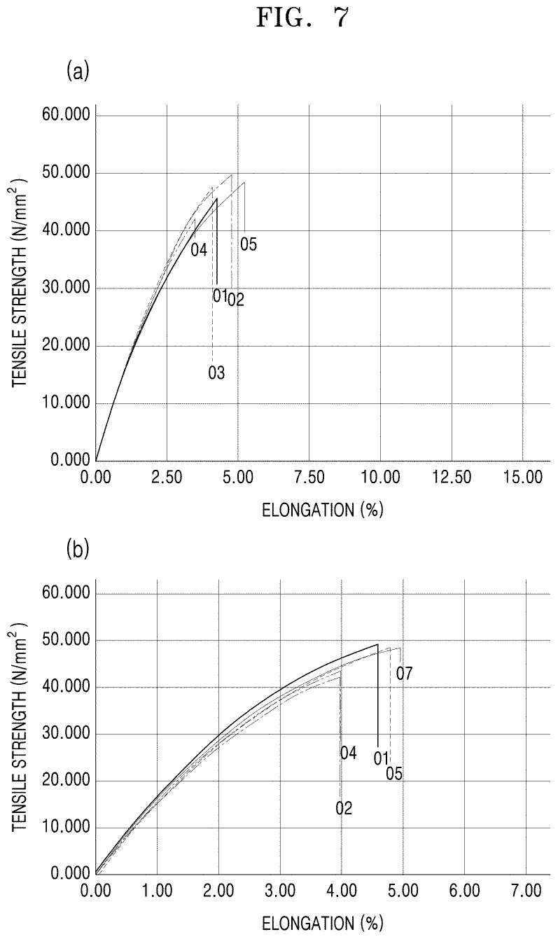

FIG. 8 shows cytotoxicity evaluation results for the cytotoxicity test specimens according to an example.

### BEST MODE

Hereinafter, a photocurable composition for three dimensional (3D) printing, including a novel polysiloxane compound according to an example of the present disclosure, a method of preparing the polysiloxane compound, and a dental model for 3D printing including the photocurable composition according to an example of the present disclosure will be described in detail. The following is presented as an example, and does not limit the present disclosure, and the present disclosure is to be defined by the scope of the following claims.

[Photocurable Composition for 3D Printinq]

The present disclosure provides a photocurable composition for 3D printing including a polysiloxane compound represented by Formula 1.

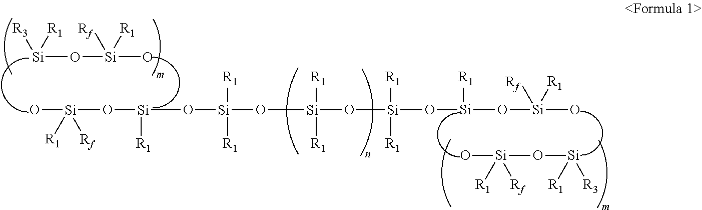

wherein, in Formula 1, R₁ is each independently selected from a C₁-C₃₀ alkyl group or a C₆-C₃₀ aryl group, R₃ is each independently selected from H, OH, a C₂-C₃₀ alkenyl group, or a C₁-C₃₀ alkoxy group, R_{f} is a photocurable group, n is an integer and satisfies the condition of 0≤n≤100, and m is an integer and satisfies the condition of 0≤m≤20.

The photocurable composition for 3D printing according to the present disclosure includes a polysiloxane represented by Formula 1 containing a linear polysiloxane as a main chain and a cyclic polysiloxane as a end group. As a result, the photocurable composition may have improved properties in terms of optical properties, tensile strength, warpage, elongation, biocompatibility, and the like, and thus, may be used as 3D printing materials in the field of electronic materials and biotechnology.

R₁ may be a substituted or unsubstituted C₁-C₃₀ alkyl group or C₆-C₃₀ aryl group, and, in particular, may be a methyl group, an ethyl group, a propyl group, an isopropyl group, an n-butyl group, a phenyl group, a naphthyl group, and the like. In the aspect of the coloring resistance against heat and the coloring resistance against light of the cured product, R₁ may be a methyl group.

The term “substitution” refers to a substitution of one or more of hydrogen atoms included in a functional group with a halogen atom, a C₁-C₂₀ alkyl group, a C₁-C₂₀ alkoxy, a C₂-C₂₀ alkoxyalkyl, a hydroxy group, a nitro group, a cyano group, an amino group, an amidino group, a hydrazine, a hydrazone, a carboxyl group or a salt thereof, a sulfonyl group, a sulfamoyl group, a sulfonic acid group or a salt thereof, a phosphoric acid group or a salt thereof, or a C₁-C₂₀ alkyl group, a C₂-C₂₀ alkenyl group, a C₂-C₂₀ alkynyl group, a C₁-C₂₀ heteroalkyl group, a C₆-C₂₀ aryl group, a C₆-C₂₀ arylalkyl group, a C₆-C₂₀ heteroaryl group, a C₇-C₂₀ heteroarylalkyl group, a C₆-C₂₀ heteroaryloxy group, a C₆-C₂₀ heteroaryloxyalkyl group, or a C₆-C₂₀ heteroarylalkyl group.

The “halogen atom” includes fluorine, bromine, chlorine, iodine and the like.

The “alkyl” refers to a fully saturated branched or unbranched (or straight or linear) hydrocarbon group. Non-limiting examples of an alkyl include methyl, ethyl, n-propyl, isopropyl, n-butyl, isobutyl, sec-butyl, n-pentyl, isopentyl, neopentyl, iso-amyl, n-hexyl, 3-methyl hexyl, 2,2-dimethylpentyl, 2,3-dimethylpentyl, n-heptyl, and the like.

The “aryl” includes groups in which an aromatic ring is fused to one or more carbon rings. Non-limiting examples of an aryl include phenyl, naphthyl, tetrahydronaphthyl and the like.

R₃ may each independently be H, OH, a C₂-C₃₀ alkenyl group, or a C₁-C₃₀ alkoxy group.

The “alkenyl” refers to a branched or unbranched hydrocarbon group having at least one carbon-carbon double bond. Non-limiting examples of an alkenyl include vinyl, allyl, butenyl, isopropenyl, and isobutenyl.

The “alkoxy” refers to an alkyl bonded to an oxygen atom.

When R₃ is an alkenyl group containing a carbon-carbon double bond, R₃ may be the same as R_{f}. For example, R₃ and R_{f} may both be vinyl groups.

R_{f} may be a photocurable group. Examples of the photocurable group are a vinyl group, an acryl group, a methacryl group, a thiol group, and an epoxy group, or the like. Preferably, the photocurable group may be a vinyl group, an acryl group, or a methacryl group. In addition, in consideration of the ease and marketability of the 3D printing process, the photocurable group may preferably be a methacryl group.

n may be an integer and may satisfy the condition of 0≤n≤100. In one example, n may be an integer and may satisfy the condition of 1≤n≤20. In one example, n may be an integer and may satisfy the condition of an integer of 1≤n≤10. When n is in these ranges, the cured product is excellent in terms of coloring resistance against heat, coloring resistance against light, and a mechanical strength.

m may be an integer and may satisfy the condition of 0≤m≤20. In one example, m may be an integer and may satisfy the condition of 0≤m≤10. In one example, m may be an integer and may satisfy the condition of 0≤m≤5. When m is in these ranges, the cured product is excellent in terms of coloring resistance against heat, coloring resistance against light, and a mechanical strength.

The equivalent amount of the photocurable group (R_{f}) in the polysiloxane compound may be from 1 g/eq to 200 g/eq, for example, 10 g/eq to 100 g/eq. When the equivalent amount of the photocurable group (R_{f}) is in these ranges, the obtained cured product may be excellent in terms of transparency, coloring resistance against heat, bendability, tensile strength, elongation, and tensile modulus. In addition, when the equivalent amount of the photocurable group exceeds 200 g/eq, the viscosity may rise sharply to lower the UV light curing rate, and when the equivalent amount of the photocurable group is less than 1 g/eq, the surface hardness of the cured product is too high and thus the cured product may be broken finely during processing (e.g., surface cutting working), or coloring resistance against heat thereof may be degraded.

The polysiloxane compound may be liquid at a temperature of about 20° C. to about 40° C. Therefore, it is easy to control the molecular weight thereof by adjusting the reaction time or the amount of catalyst, and further to control the viscosity. In addition, the polysiloxane compound may form a composition together with other resins of liquid type without the use of a solvent. Accordingly, a coating solution for 3D printing can be easily prepared.

In regard to the formulation of the photocurable composition according to the present disclosure, the composition may further include, in addition to the polysiloxane compound of Formula 1, an organic composite resin or a silicone resin, a crosslinking agent, a photoinitiator, a reactive solvent, and the like.

In the photocurable composition, the polysiloxane compound of Formula 1 may be used alone, but may further include an organic composite resin or a silicone resin.

Examples of the organic composite resins include urethane acrylate resins, bisphenol acrylate resins, polyester acrylate resins, and polyether acrylate resins, and polyether/urethane diacylate resins, and the like, which are commercially available UV-curable organic polymers.

The silicone resin may be a compound represented by the formula (R₇SiO_{3/2})_{w}(R₈R₉SiO)ₓ(Me₃SiO_{1/2})_{y}. Herein, R₇ to R₉ may each independently be a C₁-C₃₀ alkyl group or a C₆-C₃₀ aryl group, which include a vinyl group, an acryl group, a methacryl group, an epoxy group, or an ether group, and w may satisfy the condition of 0≤w<1, x may satisfy the condition of 0<x<1, and y may satisfy the condition of 0<y<1, and x, y, and z may satisfy the condition of w+y+z=1. However, at least one of R₇ to R₉ may preferably include a vinyl group, an acryl group, or a methacryl group, in consideration of the photocuring rate.

In one or more example, in a photocurable composition, other photocurable resins can also be blended therewith. Such photocurable resins include, for example, unsaturated polyester resins, photocurable acryl resins, photocurable amino resins, photocurable melamine resins, photocurable urea resins, photocurable urethane resins, ester/urethane composite resins, photocurable oxetane resins, photocurable cyanate resins, photocurable epoxy/oxetane composite resins, and cyclocarbonate polymers (for example, biscarbonate resins). Specific examples of the cyclocarbonate polymer include PEO biscarbonate, PDMS biscarbonate, and PPO biscarbonate, and their chemical structures are as follows.

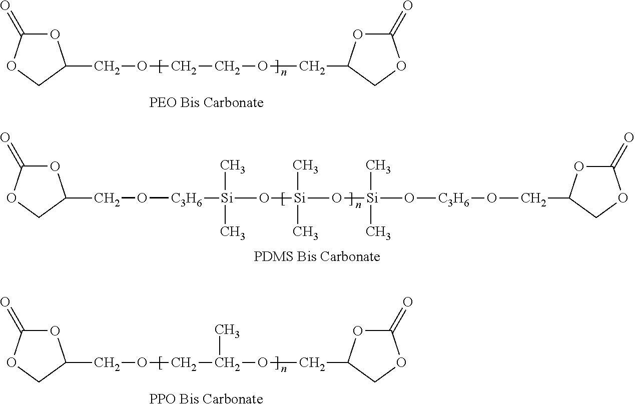

The total amount of the curable resin including the polysiloxane compound, the organic composite resin, the silicone resin, and the like included in the photocurable composition may be, based on the total weight of the curable composition, 20% by weight or more, for example, 60% by weight or more, or for example, 80 wt % or more.

As the crosslinking agent, any isocyanurate derivative compound that has an acryl group at each end thereof may be used, and any known one is not particularly limited. Examples of the isocyanurate derivative compound are diallyl isocyanuric acid, dimetallyl isocyanuric acid, monomethyl diallyl isocyanurate, monomethyl dimetallyl isocyanurate, ethyl diallyl isocyanurate, monoethyl diallyl isocyanurate, monoethyl metallyl isocyanurate, propyl diallyl isocyanurate, monopropyl diallyl isocyanurate, monopropyl dimetallyl isocyanurate, monoisoamyl diallyl isocyanurate, monoisoamyl metallyl isocyanurate, monophenyl diallyl isocyanurate, monophenyl metallyl isocyanurate, mononaphthyl diallyl isocyanurate, and mononaphthyl metallyl isocyanurate, and the like.

Among them, when used in the maxillary/mandibular tooth model, examples of the isocyanurate derivative compound preferably include diallyl isocyanuric acid, monomethyl diallyl isocyanurate, and monophenyl diallyl isocyanurate, and especially, when used for orthodontics, in consideration of physical properties, examples of the isocyanurate derivative compounds preferably include diallyl isocyanuric acid and monomethyl diallyl isocyanurate.

In addition, the crosslinking agent may include a tri-photofunctional group. When bending strength and tensile strength are taken into consideration, the core structure may include an aromatic ring, and examples thereof are a compound represented by Formula 3a or Formula 3b.

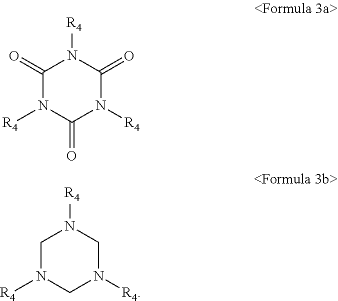

R₄ may each independently be a C₁-C₃₀ alkyl group including an ether group or a carbon-carbon double bond, and may include a moiety of Formula 4, which is non-toxic and has excellent biocompatibility, and an asterisk (*) indicates a chemical bonding site with other moieties.

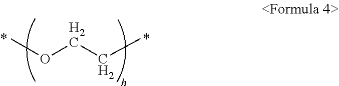

H may be an integer of 1 to 30.

Specific examples of the compound of Formula 3a may include monoallyl diglycidyl isocyanurate, triallyl isocyanurate, triglycidyl isocyanurate, diallyl monomethyl isocyanurate, and diallyl monoglycidyl isocyanurate.

Although the amount of the crosslinking agent added is not particularly limited, the equivalent ratio of the functional group in the crosslinking agent with respect to the photocurable group (R_{f}) component in the polysiloxane compound may be in the range of 0.5 to 1.5. When the amount of the crosslinking agent is outside these ranges, the unreacted photocurable groups and functional groups may remain after curing, the hardness and heat resistance of the cured product may be decreased.

The photoinitiators may be used alone or in combination, and may be liquid at room temperature. In terms of biocompatibility, the photoinitiator residue may preferably not remain in the cured product after UV curing. For example, the photoinitiator may be a 2,4,6-trimethylbenzoyl diphenyl phosphine which is widely used as a dental material.

Although the amount of the photoinitiator added is not specifically limited, the amount of the photoinitiator added may be equal to or less than 5 weight % based on the total amount of the curable composition.

In addition, in regard to the formulation of the photocurable composition, the photocurable composition may further include a pigment as an additive. As a white pigment for whitening, the photocurable composition may include one or more of silica, titanium oxide, alumina, magnesium oxide, zirconium oxide, or the like.

The amount of the white pigment may be in the range of 10 vol % to 85 vol % based on the total amount of the photocurable composition. When the amount of the white pigment is less than 10 vol %, the whiteness is insufficient and thus sufficient light reflectivity of the cured product may not be obtained. When the amount of the white pigment is more than 85 vol %, the kneading and moldability of the curable composition may deteriorate.

In addition, the photocurable composition may have a light transmittance of 80% or more, preferably 90% or more at a temperature of 25° C., with respect to UV-Vis light.

[Method of Preparation Polysiloxane Compound]

The present disclosure also provides a method of preparing the polysiloxane compound represented by Formula 1 by hydrosilylation, sol-gel reaction, alcohol condensation, or dehydration condensation of the compound of Formula 1a and the compound of Formula 1b shown below:

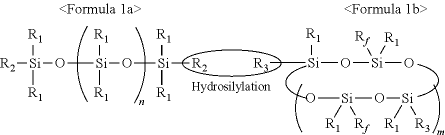

In Formula 1a, Formula 1b, and Formula 1, R₁ may each independently be selected from a C₁-C₃₀ alkyl group or a C₆-C₃₀ aryl group, R₂ and R₃ may each independently be selected from H, OH, a C₂-C₃₀ alkenyl group, or a C₁-C₃₀ alkoxy group, R_{f} may be a photocurable group, n is an integer and satisfies the condition of 0≤n≤100, and m is an integer and satisfies the condition of 0≤m≤20.

(1) Hydrosilylation Reaction

A polysiloxane compound represented by Formula 1 may be prepared by reacting a polysiloxane compound having Si—H at both ends thereof with a cyclic polysiloxane having a carbon-carbon double bond at a theoretical amount or more to perform an end group termination reaction.

For example, as shown in Reaction Example 1, the hydrosilylation reaction may be performed by using a linear polysiloxane having Si—H at both ends thereof and a cyclic polysiloxane having a vinyl group at both ends thereof.

<Reaction Example 1: Hydrosilylation Reaction>

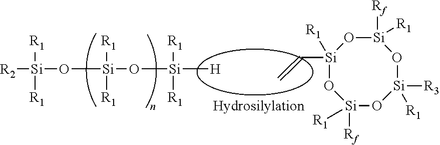

Specifically, a linear polysiloxane having Si—H at both ends is introduced into a reaction system, and then, a cyclic polysiloxane having a vinyl group at both ends thereof is introduced thereto. Herein, the end termination reaction may be carried out using the Si—H group and the reactive vinyl group and considering the time at which the Si—H group disappears completely as a time at which the reaction is completely carried out. Preferably, when the reaction is completed, the Si—H group of the polysiloxane compound having Si—H at both ends thereof may remain in an amount of less than 10%.

The hydrosilylation reaction may be carried out in the presence of a metal catalyst. The metal catalyst may be any metal catalyst that is known, and metal and metal complex compounds may be used therefor.

For example, the metal catalyst may be platinum (Pt), rhodium (Rh), palladium (Pd), iridium (Ir), or the like. In addition, these metals may be used while being immobilizing on a particulate carrier material such as carbon, activated carbon, aluminum oxide, silica, or the like.

The metal complex compound may be a platinum halogen compound (for example, PtCl₄, H₂PtCl₆.6H₂O, Na₂PtCl₆.4H₂O, etc.), a platinum-olefin complex, a platinum-alcohol complex, a platinum-alcoholate complex, a platinum-ether complex, a platinum-carbonyl complex, a platinum-ketone complex, a platinum-vinyl siloxane complex, such as platinum-1,3-divinyl-1,1,3,3-tetramethyldislioxiane, bis(y-picoline)-platinum dichloride, trimethylene dipyridine-platinum dichloride, dicyclopentadiene-platinum dichloride, cyclooctadiene-platinum dichloride, cyclopentadiene-platinum dichloride, bis(alkynyl) bis(triphenyl phosphine) platinum complex, bis(alkynyl)(cyclooctadiene)platinum complex, rhodium chloride, tris(triphenyl phosphine)rhodium chloride, tetrakis ammonium rhodium chloride complex, or the like.

The metal catalyst may be used alone or may be added to the reaction system after diluting in advance in a solvent. The metal catalysts may be handled under a nitrogen atmosphere, and may preferably be handled in a glove box to avoid contact with air and water. The ratio of the metal catalyst is not particularly limited, but the amount of the platinum catalyst used in the hydrosilylation reaction may be in the range of 0.1 ppm to 100,000 ppm, with respect to the total weight of the raw materials used, in terms of non-toxicity and biocompatibility, the ratio of the metal catalyst may be in the range of 0.5 ppm to 5 ppm.

The temperature condition of the hydrosilylation reaction may not limited, and may be in the range of 0° C. to 200° C., preferably, 30° C. to 130° C. When the temperature of the hydrosilylation reaction is less than 0° C., the reaction may proceed long, and when the temperature of the hydrosilylation reaction is higher than 200° C., the addition reaction rate is very fast and thus the control of the molecular weight may not be achieved appropriately.

(2) Sol-Gel, Alcohol Condensation, or Dehydration Condensation Reactions

A polysiloxane compound represented by Formula 1 may be prepared by performing a sol-gel, alcohol condensation or dehydration condensation reaction, instead of the hydrosilylation reaction.

The silicone composition may be easily broken due to its low impact strength compared to organic compositions. In response to this issue, a sol-gel method in which low temperature synthesis is possible, achieving high degree of purification is easy, and uniformity of composition is high, may be used.

For example, as shown in Reaction Example 2, a sol-gel reaction may be performed in such a manner that a linear polysiloxane having an alkoxy (for example, methoxy) group at both ends is reacted with a cyclic polysiloxane having Si—H at both ends thereof at an amount of less than the theoretical amount, and then, the remaining Si—H group is substituted with a Si—OH group.

<Reaction Example 2: Sol-Gel Reaction>

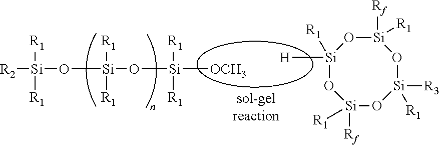

As an another example of the method, as shown in Reaction Example 3, the alcohol condensation reaction may be performed, and as an yet another example of the method, as shown in Reaction Example 4, a dehydration condensation reaction may be performed.

<Reaction Example 3: Alcohol Condensation Reaction>

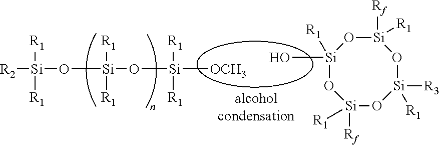

<Reaction Example 4: Dehydration Condensation Reaction>

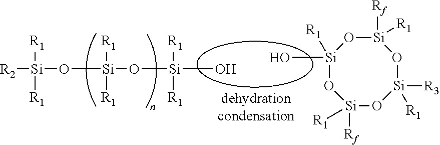

[Dental Model]

The present disclosure also provides a dental model including the photocurable composition for 3D printing. Currently, organic polyethylene terephthalate(PET)-based resins, which are mainly used for orthodontics, contain a large amount of aromatic rings in the resin back-bone thereof. Accordingly, they deteriorate easily by ultraviolet rays and cured products hereof may be easily deformed or discolorized. In addition, the use of general-purpose UV curable organic resins is limited in the medical field requiring biocompatibility because it is not easy to remove the metal catalyst used in the manufacture.

The photocurable composition according to the present disclosure may have improved optical properties, tensile strength, warpaqe properties, elongation, biocompatibility, etc. and thus can be used as a material for 3D printing in electronic materials and biotechnology. Compared to orthodontic films currently used for dental purposes, the photocurable composition has excellent properties in terms of tensile strength, elongation, tensile modulus, biocompatibility, etc. Accordingly, the photocurable composition may be used for dental models for impression or dental models for orthodontics.

### MODE OF DISCLOSURE

### Example 1. Preparation of Photocurable Polysiloxane Compounds

Photocurable polysiloxane compounds were prepared by each of the following reactions using linear polysiloxanes and cyclic polysiloxanes.

### Example 1.1 Hydrosilylation Reaction

### Example 1.1.1 Photocurable Group (R_{f}: Vinyl Group)

In the nitrogen atmosphere, 1.9 g of 2,4,6,8-tetramethyl-2,4,6,8-tetravinyl-cyclotetrasiloxane represented by Formula 2b having a vinyl group as a photocurable group (R_{f}) (Gellest Inc., 95% D4H, 0.078 mol) was dissolved in 220 m of purified THF, and 0.8 g of carbon-supported platinum (the amount of platinum loaded was 3%) was added thereto, and the mixture was stirred at room temperature. After the temperature of the reaction vessel was cooled to 10° C., the organohydrogensiloxane compound (0.195 mol) having a hydrosilyl group at both ends represented by Formula 2a was slowly added dropwise thereto while the temperature was raised up to 100° C. Then, a solution prepared by dissolving 1.02 g of monoallyldiglycidyl isocyanurate in dioxane, was added dropwise to the reaction vessel for 1 hour, and the temperature of the flask was raised to 110° C. and the reaction was carried out while refluxing.

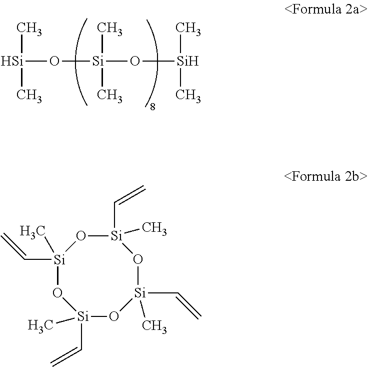

The reaction solution was added dropwise to a 0.1 N potassium hydroxide/methanol solution to confirm that no hydrogen gas was generated. Then, the platinum catalyst present in the reaction solution was filtered off with Celite, and the solvent was evaporated therefrom, thereby obtaining a compound represented by Formula 2, the yield being 82%.

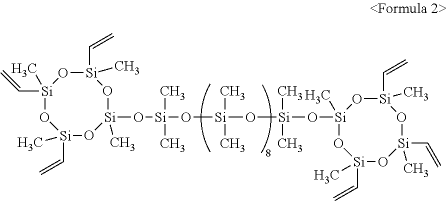

The physical properties of the compound of Formula 2 were as follows.

Vinyl equivalents: 320 g/mol, viscosity (25° C.): 5.9 Pa·s, and liquid at room temperature.

### Example 1.1.2: Photocurable Group (R_{f}: Acryl Group)

A polysiloxane compound was prepared in the same manner as in Example 1.1.1 via hydrosilylation reaction, except that a compound having an acryl group instead of the vinyl group was used as the photocurable group (R_{f}) in Example 1.1.1.

### Example 1.1.3 Photocurable Group (R_{f}: Methacryl Group)

A polysiloxane compound was prepared in the same manner as in Example 1.1.1 via hydrosilylation reaction, except that a compound having a methacryl group instead of a vinyl group was used as the photocurable group (R_{f}) in Example 1.1.1.

### Example 1.2: Sol-Qel Reaction

73 parts by weight of a polysiloxane compound having a methoxy group at both ends thereof represented by Formula 2c was placed in a 500 mL three-necked flask, and 220 parts by weight of THF and 0.083 parts by weight of a tin (Sn) catalyst were added thereto, followed by stirring in a nitrogen atmosphere while the temperature was raised up to 60° C. Thereafter, 38 parts by weight of 2,4,6,8-tetramethyl-2,4,6,8-tetrahydro-cyclotetrasiloxane represented by Formula 2d was added dropwise to the flask for 1 hour, and the temperature of the flask was raised to 110° C., and the reaction was carried out while refluxing.

Thereafter, the tin catalyst present in the reaction solution was removed therefrom by filtration using a filtration filter in which Celite, MgSO₄, and Celite were stacked in this stated order, and the solvent was evaporated therefrom, and the Si—H group remaining in the reaction solution was substituted with the Si—OH group, followed by the sol-gel reaction to obtain 74 parts by weight of the compound of Formula 2 above.

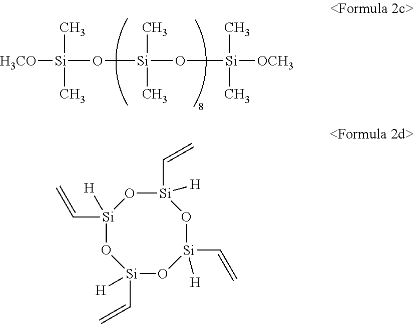

### Example 1.3: Alcohol Condensation Reaction

73 parts by weight of a polysiloxane compound having a methoxy group at both ends thereof represented by Formula 2e and 38 parts by weight of 2, 4,6,8-tetramethyl-2,4,6,8-tetrahydroxyl-cyclotetrasiloxane represented by Formula 2f were placed in a 500 mL three-neck flask, and an alcohol condensation reaction was carried out at a temperature of 80° C. to 100° C. while refluxing, thereby obtaining 74 parts by weight of the compound represented by Formula 2 above.

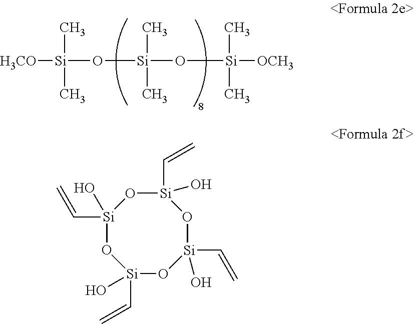

### Example 1.4 Dehydration Condensation Reaction

73 parts by weight of a polysiloxane compound having a hydroxyl group at both ends thereof represented by Formula 2g and 38 parts by weight of 2,4,6,8-tetramethyl-2,4,6,8-tetrahydroxyl-cyclotetrasiloxane represented by Formula 2h were placed in a 500 mL three-neck flask, and a dehydration condensation reaction was carried out at a temperature of 80° C. to 100° C. while refluxing, thereby obtaining 74 parts by weight of the compound represented by Formula 2 above.

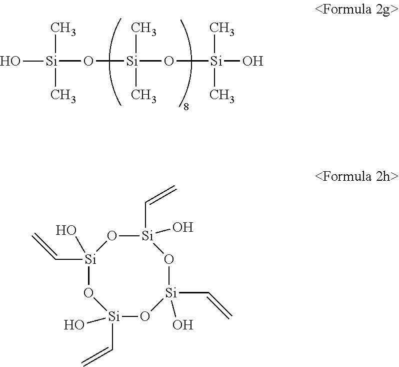

### Example 2: Preparation of Photocurable Composition and Dental Model Includinq the Same

### Example 2.1

First, 1,6-hexanediol diacrylate (HDDA), which is a reactive diluent, and 2,3,6-trimethylbenzoyl diphenylphosphine oxide (TPO), which is a photoinitiator, were mixed in a 20 mL brown vial bottle, and then, while the photocurable polysiloxane compound prepared according to Example 1.1.1 was slowly added thereto, the mixture was dispersed by using a homogenizer (IKA, ULTRA TURRAX T 25) at 19,000 rpm for two minutes. Thereafter, 7.5 g of an aliphatic urethane acrylate (product name: EBECRYL 8210, manufacturer: CYTEC Industries), which is an oligomer, was further added thereto, and then, further dispersed for 30 minutes by using a homogenizer, and bubbles were removed therefrom for 30 minutes in a vacuum oven to prepare a photocurable composition for 3D printing.

Thereafter, the composition for 3D printing was injected into a tooth mold for impression or a tooth mold for orthodontics by 3D printing, and then exposed to the radiation of UV light for 1 to 10 hours to prepare a 3D tooth model for impression or a 3D tooth model for orthodontics.

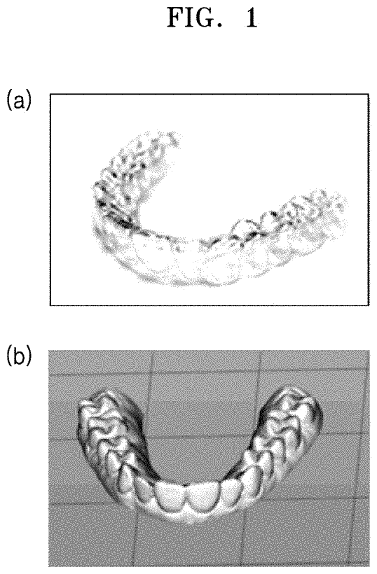

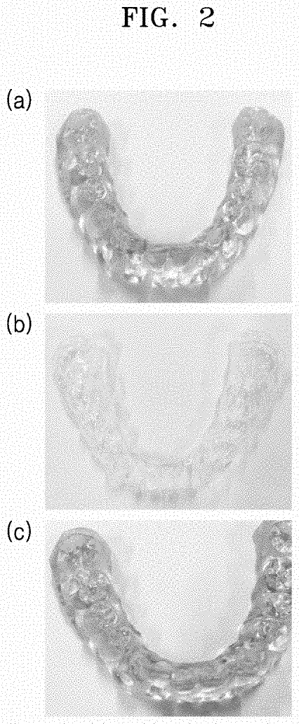

The image of the dental model for orthodontics is shown in FIG. 1, and (a) the image of a dental mandibular model for impression, (b) the image of a dental model for orthodontics, and (c) the image of a tooth mandibular model with the dental model for orthodontics mounted thereon are shown in FIG. 2.

### Example 2.2

A photocurable composition and a dental model including the same were prepared in the same manner as in Example 2.1, except that the photocurable polysiloxane compound prepared in Example 1.1.2 was used instead of the photocurable polysiloxane compound prepared in Example 1.1.1.

### Example 2.3

A photocurable composition and a dental model including the same were prepared in the same manner as in Example 2.1, except that the photocurable polysiloxane compound prepared in Example 1.1.3 was used instead of the photocurable polysiloxane compound prepared in Example 1.1.1.

### Example 2.4

A photocurable composition and a dental model including the same were prepared in the same manner as in Example 2.2, except that, as the photoinitiator, 9% benzyl dimethyl ketal (BDK) was used instead of TPO in Example 2.2.

### Example 2.5

A photocurable composition and a dental model including the same were prepared in the same manner as in Example 2.2, except that, as the photoinitiator, 6% benzyl dimethyl ketal (BDK) and 6% 1-hydroxycyclohexyl phenyl ketone (IRGACURE 184, Ciba Specialty Chemicals) were used instead of TPO.

### Example 2.6

A photocurable composition and a dental model including the same were prepared in the same manner as in Example 2.2, except that, as the photoinitiator, 9% 1-hydroxycyclohexyl phenyl ketone (IRGACURE 184) was used instead of TPO in Example 2.2.

### Example 2.7

A photocurable composition and a dental model including the same were prepared in the same manner as in Example 2.3, except that, as the photoinitiator, 9% 1-hydroxycyclohexyl phenyl ketone (IRGACURE 184) was used instead of TPO in Example 2.3.

### Example 2.8

A photocurable composition and a dental model including the same were prepared in the same manner as in Example 2.3, except that, as the photoinitiator, 6% benzyl dimethyl ketal (BDK) and 6% 1-hydroxycyclohexyl phenyl ketone (IRGACURE 184) were used instead of TPO in Example 2.3.

### Example 3 Preparation of Tensile Strength Specimens Includinq Photocurable Polysiloxane Compounds

### Example 3.1

The surface of the glass slide was coated with hexamethyldisilazane to facilitate a separation between the photocurable composite and the glass slide, and then a 2 mm-thick Teflon foam spacer made to conform to ASTM D638 was applied on the glass slide, thereby manufacturing a mold for measurement.

Thereafter, the photocurable composition prepared in Example 2.1 was injected into the mold by using a syringe, and then placed in a glove box (KOREA KIYON, KK-011-AS) under a nitrogen atmosphere, and then exposed to irradiation of UV in a UV chamber (Electro-Lite Corporation, ELC-500, 365 nm, and 30 mW/cm²) for 5 minutes to prepare five specimens for tensile strength test in the form of dog-bone.

### Example 3.2

Five specimens for tensile strength test were prepared in the same manner as in Example 3.1, except that the photocurable composition prepared in Example 2.2 was used instead of the photocurable composition prepared in Example 2.1.

### Example 3.3

Five specimens for tensile strength test were prepared in the same manner as in Example 3.1, except that the photocurable composition prepared in Example 2.3 was used instead of the photocurable composition prepared in Example 2.1.

### Example 4: Preparation of Cytotoxicity Specimens Includinq Photocurable Polysiloxane Compounds

Five specimens for toxicity testing were prepared in accordance with the test and evaluation method according to ISO 109935: 2009 Common Standards on Medical Device Biological Safety (Notification No. 2014-115 of the Korea Food and Drug Administration). The specimens were used as a test sample for cytotoxicity, after dried with distilled water, methanol, ethanol, methyl ethyl ketone (MEK) and the like.

### Evaluation Example 1: Evaluation of Optical Properties of Photocurable Polysiloxane Compound

Optical properties of the polysiloxane compound represented by Formula 1 according to Example 1 were evaluated using IR spectra and UV-Vis transmission spectra.

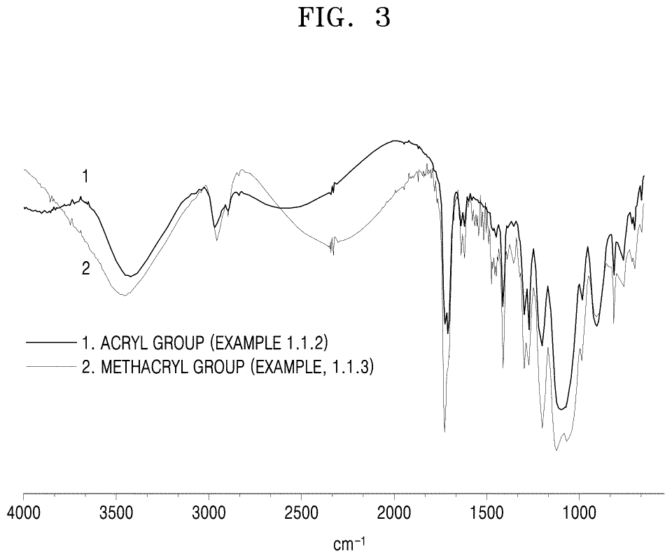

The IR spectra of the polysiloxane compound represented by Formula 1 are shown in FIG. 3. wherein photocurable groups of the polysiloxane compound are (a) an acryl group (Example 1.1.2) and (b) a methacryl group (Example 1.1.3), respectively.

As shown in FIG. 3, it can be seen from the IR spectra that the polysiloxane compound including (a) the acryl group as a photocurable group and the polysiloxane compound including (b) the methacryl group as a photocurable group were formed.

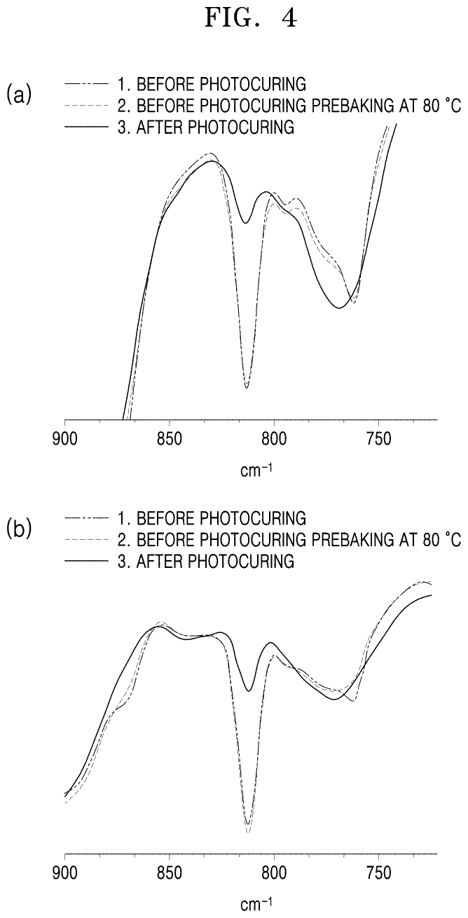

FIG. 4 shows IR spectra of the polysiloxane compound represented by Formula 1 according to an example before photocuring, before photocuring prebaking at 80° C., and after photocuring. Herein, photocurable groups of the polysiloxane compound are (a) an acryl group (Example 1.1.2) and (b) a methacryl group (Example 1.1.3), respectively.

As shown in FIG. 4, it can be seen from the IR spectra that photocuring was achieved as the peak of 800 cm⁻¹ to 850 cm⁻¹ disappeared after photocuring in both the polysiloxane compound including (a) the acryl group as the photocurable group and the polysiloxane compound including (b) the methacryl group as the photocurable group.

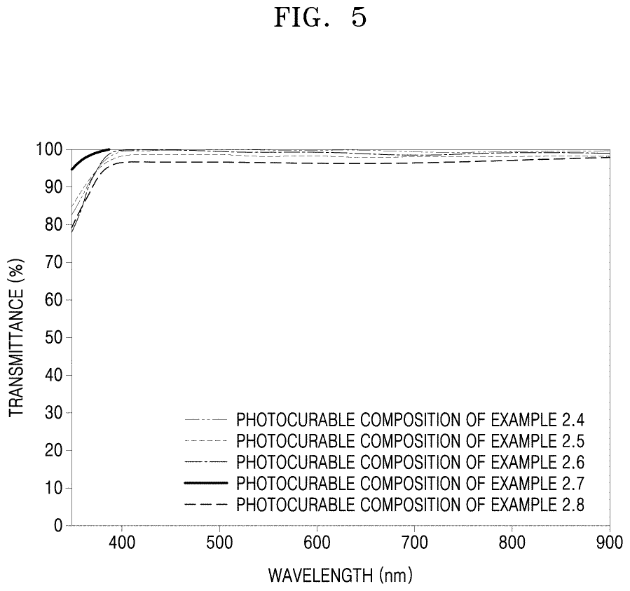

The UV-Vis transmittance spectra of the photocurable compositions according to Example 2 are shown in FIG. 5.

As shown in FIG. 5, the transmittance at 550 nm in all of the photocurable compositions of Examples 2.4 to 2.8 was found to be high, at least 98.6%. Due to the high transmittance, a high level of aesthetics was able to be obtained when used as a tooth model for orthodontics.

### Evaluation Example 2: Evaluation of Tensile Strength, Elonqation, and Tensile Modulus

The tensile strength, elongation and tensile modulus for the cured products prepared from the photocurable compositions of the present disclosure were evaluated by comparing with commercially available orthodontic films according to the ASTM D638 test standard.

### 2.1 Evaluation Accordinq to ASTM D638 Test Standard

With respect to the dog-bone shaped tensile strength test specimens according to Example 3, the tensile strength, elongation and tensile modulus thereof were measured according to ASTM D638 test standard by using a contact-type tensile tester of an automated material test system (Series IX) (Instron Corporation) of Korea Polymer Testing & Research Institute, an accredited certification body.
Test specification and condition: ASTM D638
Test device: UTM, Load cell: 3000N, Marking distance: 25.4 mm
Test speed: 50 mm/min
Elastic section: (0.2 0.5 mm), Test environment: (23±2) ° C., (45±5)% R.H

According to the method, the tensile strength, elongation, and tensile modulus of the tensile strength specimens prepared according to Examples 3.2 and 3.3 were measured. The obtained results are shown in Tables 1 and 2, respectively.

TABLE 1

| | | | | Tensile |
|---|---|---|---|---|
| Specimen | Specimen | Tensile strength | Elongation | Modulus |
| Name | number | (N/mm²) | (%) | (N/mm²) |
| Example 3.2 | 1 | 46.11 | 4.29 | 1583 |
| Specimen | 2 | 49.77 | 4.76 | 1700 |
| | 3 | 47.64 | 4.25 | 1718 |
| | 4 | 42.28 | 3.46 | 1855 |
| | 5 | 48.66 | 5.24 | 1730 |
| | Standard | 2.91 | 0.66 | 97 |
| | deviation (SD) | | | |
| | CV (%) | 6.21 | 15.05 | 5.63 |
| | Average | 46.89 | 4.40 | 1717 |

TABLE 2

| | | Tensile | | |
|---|---|---|---|---|
| Specimen | Specimen | strength | Elongation | Tensile Modulus |
| Name | number | (N/mm²) | (%) | (N/mm²) |
| Example 3.3 | 1 | 48.91 | 4.61 | 1852 |
| Specimen | 2 | 42.19 | 4.02 | 1589 |
| | 3 | 43.39 | 3.98 | 1715 |
| | 4 | 48.04 | 4.80 | 1527 |
| | 5 | 48.37 | 4.96 | 1607 |
| | Standard | 2.14 | 0.45 | 128 |
| | deviation | | | |
| | (SD) | | | |
| | CV (%) | 6.80 | 10.07 | 7.71 |
| | Average | 46.18 | 4.47 | 1658 |

As shown in Tables 1 and 2, all of the tensile strength specimens according to the present disclosure showed excellent properties in terms of tensile strength, elongation, and tensile modulus.

### 2.2 Comparative Evaluation with Commercial Dental Orthodontic Films

The tensile strength, elongation and tensile modulus of the tensile strength specimens prepared in Example 3 are shown in Table 3 in comparison with commercial dental orthodontic films.

TABLE 3

| | | | Tensile | Elon- | Tensile |
|---|---|---|---|---|---|
| | | Specimen | strength | gation | Modulus |
| Types | Specimen | Name | (N/mm²) | (%) | (N/mm²) |
| UV | Example 3 | Example 3.2 | 46.89 | 4.40 | 1717 |
| Curable | | Specimen | | | |
| Resin | | Example 3.3 | 46.18 | 4.47 | 1658 |
| | | Specimen | | | |
| | Comparative | D0.5 | 57.5 | 227 | 1726 |
| | Example 1 | D0.75 | 61.4 | 236 | 1818 |
| | (Scheu | D1 | 65.6 | 258 | 1826 |
| | Dental) | | | | |
| Heat | Comparative | S0.5 | 56.3 | 200 | 1725 |
| Thermo- | Example 2 | S0.75 | 62.6 | 274 | 1803 |
| plastic | (3A Medes, | Si | 66.6 | 251 | 1782 |
| resin | Splint) | | | | |
| | Comparative | B0.5 | 38.1 | 880 | 56.4 |
| | Example 3 | B1 | 38.1 | 852 | 49.1 |
| | (3A Medes, | | | | |
| | Bleaching) | | | | |
| | Comparative | E-Shell | 96.9 | 5.69 | 2452 |
| | Example 4 | Ortho | 57.5 | 11.5 | 1385 |
| | (Envision | | | | |
| | TEC) | | | | |
| | Comparative | A + 0.5 | 55.1 | 163 | 1712 |
| | Example 5 | A + 1 | 67.6 | 259 | 1860 |
| | (Dentsply) | ACE0.75 | 56.6 | 184 | 1540 |
| | | ACE1 | 62.4 | 196 | 1522 |
| | | C + 1 | 38.7 | 483 | 957 |

As shown in Table 3, all of the tensile strength specimens prepared in Examples 3.2 and 3.3 exhibited excellent tensile strength and tensile modulus compared to commercially available orthodontic films, while the elongation thereof was very low. That is, the degree of deformation was low. Accordingly, it can be seen that the specimens are suitable for use as a dental orthodontic model.

### Evaluation Example 3: Cytotoxicity Evaluation

The cytotoxicity of the photocurable compositions according to the present disclosure was evaluated according to ISO 109935 test standards and conditions.

(A) Test standard and conditions: ISO 109935

(B) Cell line: L929 cell (CCL-1, ATCC, USA)

(C) Positive control group: Polyurethane film containing 0.1% zinc diethyldithio-carbamate (ZDEC) (RM-A, Hatano Research Institute, Japan)

(D) Negative Control: High Density Polyurethane Film (RM-C, Hatano Research Institute, Japan)

(E) Evaluation criteria

\textcircled{1} Cytotoxicity is evaluated by observing the number of round cells (dead cells) to determine the cytotoxicity and the cytotoxicity grade.

\textcircled{2} The cytotoxicity grade shall be judged correctly based on the following conditions.

<Qualitative Morphological Grade of Eluate Cytotoxicity>

TABLE 4

| | Respon- | |
|---|---|---|
| Grade | siveness | State of cultured cells |
| 0 | None | Isolation of intracytoplasmic granules, no cell lysis, |
| | | no inhibition of cell growth. |
| 1 | Slight | No more than 20% cells were round in shape and |
| | | loosely adhered, and intracytoplasmic granules |
| | | thereof had lost or changed morphology. |
| | | Occasionally lysed cells were present and the |
| | | growth thereof was slightly inhibited. |
| 2 | Mild | No more than 50% of cells were round in shape and |
| | | intracytoplasmic granules thereof were lost, and no |
| | | extensive cytolysis, and no more than 50% of cell |
| | | growth inhibition. |
| 3 | Moderate | No more than 70% cells were round or lysed. The |
| | | cell layer was not completely destroyed, but 50% or |
| | | more cells showed a growth inhibition. |
| 4 | Severe | Cell layer was almost or completely destroyed. |

\textcircled{3} In the positive control group and the negative control group, when the response in the test solution is greater than the grade 2 (>2), it was determined that there is cytotoxicity.

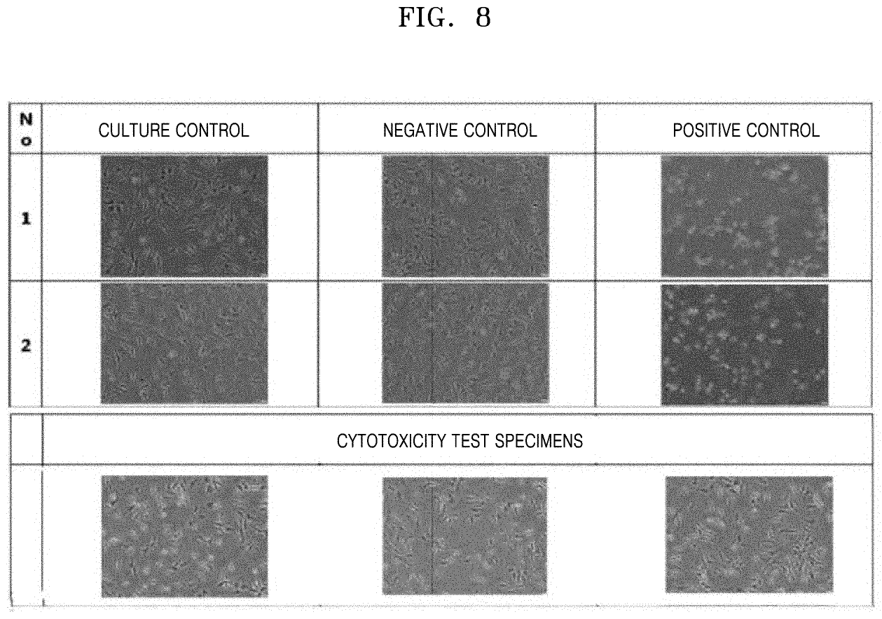

The cytotoxicity evaluation results for the cytotoxic test specimens according to Example 4 are shown in FIG. 8.

As shown in FIG. 8, the cytotoxic test specimens according to Example 4 showed that the cells continue to survive in the culture state of the cells, which indicates that there is no inhibition to cell growth. In addition, the results showed Grade zero of cell nontoxicity at the response evaluation level.

### Evaluation Example 4: ICPAES Component Analysis

ICPAES component analysis experiments were carried out on the raw materials (reactive monomers, crosslinking agents, aliphatic urethanes and aromatic urethanes) used in Examples of the present disclosure to evaluate the presence of heavy metals and harmful elements.

As a result, it was confirmed that all of the raw materials did not contain heavy metals and harmful elements, and the elements that are harmful in the human body were detected at 5 ppm or less.

1. A photocurable composition for 3D printing, comprising a polysiloxane compound represented by Formula 1, a silicone resin, a crosslinking agent, and a photoinitiator: 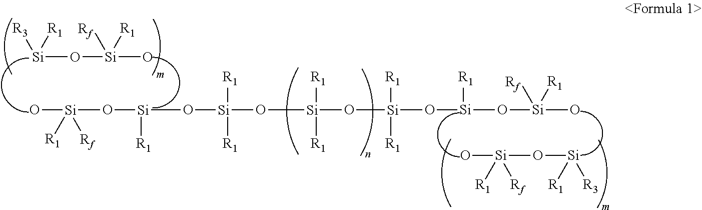
wherein, in Formula 1, R₁ is each independently selected from a C₁-C₃₀ alkyl group or a C₆-C₃₀ aryl group, R₃ is each independently selected from H, OH, a C₂-C₃₀ alkenyl group, or a C₁-C₃₀ alkoxy group, R_{f} is a photocurable group, n is an integer and satisfies the condition of 0≤n≤100, and m is an integer and satisfies the condition of 0≤m≤20,
the silicone resin is a compound represented by (R₇SiO_{3/2})_{w}(R₈R₉SiO)ₓ(Me₃SiO_{1/2})_{y}, wherein R₇ to R₉ are each independently a C₁-C₃₀ alkyl group or a C₆-C₃₀ aryl group which includes an acryl group, a methacryl group, an epoxy group, or an ether group, and
w satisfies the condition of 0≤w<1, x satisfies the condition of 0<x<1, y satisfies the condition of 0<y<1, and w, y, and z satisfy the condition of w+y+z=1.

2. The photocurable composition of claim 1, wherein R₁ is a methyl group.

3. The photocurable composition of claim 1, wherein the photocurable group (R_{f}) is a vinyl group, an acryl group, a methacryl group, a thiol group, or an epoxy group.

4. The photocurable composition of claim 1, wherein the equivalent amount of the photocurable group (R_{f}) in the polysiloxane compound is 1 g/eq to 200 g/eq.

5. The photocurable composition of claim 1, wherein the polysiloxane compound is liquid at a temperature of 20° C. to 40° C.

6. The photocurable composition of claim 1, wherein the crosslinking agent is a compound represented by Formula 3a or 3b: 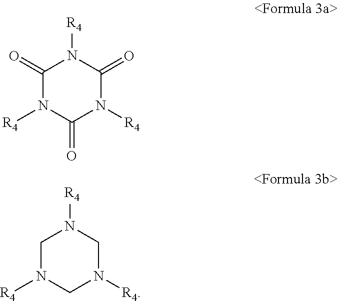
wherein, in Formulae 3a and 3b, R₄ is each independently a C₁-C₃₀ alkyl group including an ether group or a carbon-carbon double bond.

7. The photocurable composition of claim 6, wherein the compound of Formula 3a is selected from the group consisting of monoallyl diglycidyl isocyanurate, triallyl isocyanurate, diallyl isocyanurate, diallyl monomethyl isocyanurate, and diallyl monoglycidyl isocyanurate.

8. The photocurable composition of claim 6, wherein R₄ comprises a compound represented by Formula 4: 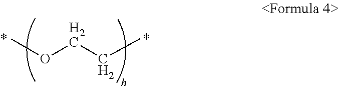
wherein, in Formula 4, h is an integer of 1 to 30.

9. The photocurable composition of claim 1, wherein the photoinitiator is 2,4,6-trimethylbenzoyl diphenyl phosphine.

10. The photocurable composition of claim 1, wherein the photocurable composition forms a cured product having a light transmittance of 80% or more with respect to ultraviolet (UV) light at 25° C.

11.-14. (canceled)

15. A dental model comprising the photocurable composition of claim 1.

16. The dental model of claim 15, wherein the dental model is a dental model for impression or a dental model for orthodontics.
